(19) United States
(12) Patent Application Publication
(10) Pub. No.: US 2007/0002837 A1
(43) Pub. Date: Jan. 4, 2007

(54) VOIP access cellphone adapter

(76) Inventor: Eric Tan, Bellevue, WA (US)

Correspondence Address: ANTHONY CLAIBORNE, 849 136TH AVE. N.E., BELLEVUE, WA, 98005, US

(21) Appl. No.: 11/348,728

(22) Filed: Feb. 6, 2006

Related U.S. Application Data
(60) Provisional application No. 60/696,455, filed on Jul. 1, 2005.

(51) Int. Cl. H04L 12/66

(52) U.S. Cl. 370/352

(57) ABSTRACT

A portable adapter for a cellular telephone set enables the use of the handset for wireless voice over Internet protocol communications. Some embodiments of the present invention further enable such communication over wired connection, such as Ethernet. Some embodiments further provide a means for using the adapter to provide VOIP capabilities for wired standard telephone sets. Some embodiments further provide power to the cellular telephone set. Some embodiments provide means for control communications with the adapter along with signal communications carried by the adapter. Preferred embodiments employ a form factor appropriate for portability, with some embodiments implemented in a form factor conforming to that of the cellular handset battery, thereby enhancing portability and utility.

### CROSS-REFERENCE TO RELATED APPLICATION

This application claims priority from U.S. provisional application No. 60/696,455, filed Jul. 1, 2005, entitled WIRELESS VOIP ADAPTER FOR CELLULAR TELEPHONE SET.

### BACKGROUND OF THE INVENTION

1. Field of the Invention

This invention relates to voice telephony. More particularly, this invention relates to means for adapting cellular telephone handsets to provide voice telephone service in modalities other than cellular, including wireless voice over internet protocol communications.

2. Description of the Related Art

The now ubiquitous cellular radio telephone, also called cellular telephone or cell phone, comprises a low-powered, lightweight radio transceiver (combination transmitter-receiver) that provides voice telephone and other services to mobile users. Cellular telephones primarily operate like portable or cordless telephones. However, unlike conventional wire-based cordless phones, cellular telephones are completely portable and do not require proximity to a jack to access the wire-based networks operated by local telephone companies.

Because of their convenience and portability the use of cellular telephones have become very popular with professionals and consumers as a way to communicate while away from their regular, wire-based phones, for example, while traveling or when in remote locations lacking regular phone service. As cellular radio service proliferates and achieves greater market penetration, some users have begun to consider it an alternative to or even replacement for conventional wire-based services.

Cellular telephones work by transmitting radio signals to cellular towers. These towers vary in their capability to receive cellular telephone signals. Some towers can receive signals from distances of only 1.5 to 2.4 km (1.0 to 1.5 mi), while others can receive signals from distances as far as 48 to 56 km (30 to 35 mi). The area a tower can cover is referred to as a cell. However, more than one tower may exist in a given cell area. The cells overlap so that the system can handle increased telephone traffic volume. The towers within these cells are networked to a central switching station, usually by wire, fiber-optic cable, or microwave. The central switching station handling cellular calls in a given area is directly connected to the wire-based telephone system. Cellular calls are picked up by the towers and relayed to another cell telephone user or to a user of the conventional wire-based telephone network. Since the cells overlap, as a mobile caller moves from one cell into another, the towers “hand off” the call so communication is uninterrupted. Cellular telephone service is thereby integrated into the public switched telephone network (PSTN).

Cellular phone networks exist in nearly every metropolitan area throughout the world, and cellular coverage is expanding in rural areas. A newer generation of cellular radio technology, called Personal Communications Services (PCS), operates much like earlier cellular services, but at higher frequencies. (The higher frequencies of PCS operate at around 1900 megahertz [MHz] in the United States.) PCS also utilizes completely digital transmissions, rather than both the analog and digital transmissions that older cellular telephones use. Digital transmissions convert sound into digital form, which can be transmitted more efficiently than analog signals. Digital technologies can also generate more channel capacity over the same amount of the radio spectrum.

Both analog cellular radio and PCS use high-frequency radio waves to transmit calls. High-frequency waves have short wavelengths that pass by a given point at a very high rate. High-frequency waves can provide better sound quality and more reliable short-distance transmission than lower-frequency waves (such as AM radio) as they are less susceptible to sound degradation caused by the noise generated by weather, such as lightning which causes static, and other noise generators such as motors. However, high-frequency signals cannot effectively travel as far as low-frequency signals can.

For cellular networks, the limited range of high-frequency waves is actually advantageous because it means the same frequencies can be reused at nearby locations. Cell phone calls connect with short-range antennas known as towers. If there were only one tower for a large area, more customers would be trying to use the same high-frequency waves, and these waves would tend to overlap and cause interference. But because cell phone networks establish many towers covering small areas, a smaller number of customers access a given tower, and frequencies can be reused when a cell phone call is handed off from one tower to another as a mobile cell phone user travels. This ability to reuse frequencies is helpful because there are a limited number of radio frequencies available to cell phone companies. It also allows cellular network providers to accommodate a larger number of users.

The cells in a cellular radio network refer to the coverage area of each tower that receives and transmits calls from mobile telephones. The cells are arranged in a honeycomb pattern, and they overlap so that the system can handle increases in anticipated telephone traffic volume. Network management functions, performed by computers at a central facility known as a Mobile Telephone Switching Office (MTSO), include the ability to measure and compare the transmission quality between a single handset and multiple towers. This function is important so that the MTSO can select the best transmission link between mobile telephones and towers. This optimal link is then used to pass transmissions from one tower to another as the mobile telephone moves between cells.

All cell towers in a given area connect with the MTSO, which in turn has links to the wire-based local exchange carrier that handles normal telephone calls. The link between the MTSO and the wire-based local telephone company is essential for connecting wireless and wire-based calls. The vast majority of calls handled by a cellular radio network either begin on the wire-based network or end there.

Of particular relevance to the present invention, cellular telephone handsets comprise, in part, a basic telephone set containing a microphone and analog transmitter for transferring the caller's voice; an analog receiver and speaker for amplifying and reproducing sound from an incoming call; a push button dial; ringer or alerter functionality; and a small assembly of electrical parts, called the antisidetone network, that keeps the caller's voice from sounding too loud through the receiver. The components comprising the basic telephone set functionality of the cellular phone are then coupled to a cellular transceiver to provide cellular telephone functionality.

The transceiver inside a cellular phone is much more complex device than that employed to couple a conventional phone to the wire-based network. A cellular telephone has circuitry that creates a unique identity code that is used to locate and track the telephone. This identity code is necessary for coordinating calls to and from the telephone, identifying the cellular handset and its associated specific cellular service provider to the cellular network, thereby enabling the cellular service provider to bill the user for cell calls. Because a cellular telephone user may move quite a distance during the duration of a call, the cellular radio network must manage calls from different tower sites as the telephone moves out of the range of one tower and into the range of another tower.

In addition to basic telephone and cellular functionality, current cellular telephones offer such features as a memory database for storing frequently called numbers and a lock to deter theft. Most cell phones, whether old or new, also have a small liquid crystal screen to display the telephone number being called or the number from which an incoming call originated. Most newer cell phones can display a short text message, much like a pager displays this information. Some more modern cellular phones can also access the Internet and display text from Web sites, such as stock quotes and news stories. Internet-capable cell phones can also send and receive e-mail. Modern cell phones further often include a color liquid crystal display screen, allowing them to render graphics including visual media presented via the Internet, as well as advanced audio processing capabilities allowing reproduction of MIDI (Musical Instrument Digital Interface) files and digital audio media such as files in .wav format.

Furthermore, many modern cell phones provide wireless connectivity to other devices, such as a personal computer or a microphone headset, via short range radio communications, in particular via the Bluetooth protocol. In the case of the personal computer, such connectivity enables the uploading and downloading of text or media files to and from the telephone handset, while connectivity to a microphone headset allows hands-free usage of the cell phone for telephone conversation. With increasing cell phone handset capabilities, because few cell phone handsets allow for upgrading, the rapid obsolescence of a cell phone handset is the rule rather than the exception, and a user may find the capabilities of an older handset limited to the point of requiring replacement of the handset within just a few years of purchase.

Because it uses radio waves to send and receive calls, and because it may also provide at least some of the advanced capabilities such as those set forth above, a cellular telephone handset must include a power source. Removable rechargeable batteries provide the usual source of power, but most cell phones can also be attached to the cigarette lighter in a vehicle or to some other external power device.

Due to the convenience and mobility of cellular telephones, users typically pay a higher fee for cellular telephone service than they would pay for wired telephone service: often this fee is much higher. Competing cellular telephone service providers offer users competing rate plans. As explained above, a cellular telephone handset is configured to identify the user's specific cellular service provider to the network. When a user changes cellular telephone service providers, the user's cellular telephone needs to identify the user's new carrier to the network, so that the user's calls may be handled and billed by the new carrier. Most cell phone handsets are sold to a user by the user's cellular service provider (often at substantial discount) and are pre-configured for the service provider's network. When a user changes carriers, there often is no easy way for the user to reconfigure the cellular telephone handset for the new carrier. Therefore, when users change cellular carriers, they often simply abandon their old cell phone handset, purchasing a new set configured for the new carrier.

A concurrent development in telephony technology is voice over internet protocol networks, which provides the routing of voice conversations over the Internet or any other general-purpose packet-switched network, instead of traditional dedicated, circuit-switched voice transmission lines. A number of related art patents have issued that are directed to inventions in this area of technology (e.g. U.S. Pat. No. 6,243,373 to Turock, assigned to Acceris Communications, Inc. of San Diego, Calif.).

Protocols used to carry voice signals over the IP network are commonly referred to as Voice over IP or VOIP protocols. Voice over IP traffic may be deployed on any IP network, for instance on a private building-wide LAN. Of particular interest for the present invention, however, is the use of VOIP technology to carry voice signals over the Internet.

While several protocols have been considered and used for VOIP, the emerging dominant protocol today is Session Initiation Protocol, or SIP, as defined by the Internet Engineering Task Force (IETF), a standards body for various software and data transmission protocols for the Internet.

A goal for SIP was to provide a superset of the call processing functions and features present in the PSTN. As such, features that permit familiar telephone-like operations are present: dialing a number, causing a phone to ring, hearing ringback tones or a busy signal. Implementation and terminology are different. SIP also implements many of the more advanced call processing features present in Signalling System 7 (SS7), although in an entirely different manner. SS7 is a highly centralized protocol employed in the PSTN, characterized by highly complex central network architecture and dumb endpoints, such as traditional telephone handsets.

SIP is a peer-to-peer protocol. As such it requires only a very simple (and thus highly scalable) core network with intelligence distributed to the network edge, embedded in endpoints (terminating devices built in either hardware or software). Many SIP features are implemented in the communicating endpoints as opposed to traditional SS7 features, which are implemented in the network.

SIP works in concert with several other protocols and is only involved in the signaling portion of a communication session. SIP acts as a carrier for the Session Description Protocol (SDP), which describes the media content of the session, e.g. what IP ports to use, the coder-decoder (codec) being used, etc., as is well known by those of skill in the art. In typical use, SIP “sessions” are simply packet streams of the Real-time Transport Protocol (RTP). RTP is the carrier for the actual voice content itself, the content in turn comprised of voice data packetized according to the User Datagram Protocol (UDP, one of the core protocols of the Internet protocol suite) very familiar to those in the art.

SIP is similar to Hypertext Transfer Protocol (HTTP) and shares some of its design principles—it is human readable, very simple and based upon request-response. It shares many HTTP status codes, such as the familiar ‘404 not found’. Much of the promise of SIP is that the rapid innovation and application development that has characterized the Web will now mark the telephony industry, too.

SIP makes use of elements called proxy servers to help route requests to the user's current location, authenticate and authorize users for services, implement provider call-routing policies, and provide features to users. SIP also provides a registration function that allows users to upload their current locations for use by proxy servers. Since registrations play an important role in SIP, a user agent server that handles a register is given the special name “registrar”. It is an important concept that the distinction between types of SIP servers is logical, not physical.

SIP is not limited to voice but can mediate any kind of communication session from voice to video or future, unrealized applications. Most relevant to the present invention, however, is that SIP and other modern VOIP protocols provide a means for users to practice voice telephony over the Internet. Acceptable voice quality, however, requires addressing service quality issues, principally those problems which are the result of transmission speed and signal processing. Broadband Internet connectivity, which is becoming ever more ubiquitous worldwide, solves the quality problems associated with transmission speed for voice communications. Signal processing problems have been solved for VOIP by employing forms of real-time transport protocol effectively to eliminate lag and latency in VOIP communications.

As is well known to those in the art, unlike the RTP employed for much other modern Internet traffic, the real-time transport protocol used to carry the media stream in SIP and most other VOIP protocols does not traverse network address translation (NAT) routers. NAT routing is a technique in which the source and/or destination addresses of IP packets are rewritten as they pass through a router or firewall. Such routing is most commonly used to enable multiple hosts on a private network to access the Internet using a single public IP address. NAT traversal, however, creates quality of service problems for the real time communication required for voice telephone conversations.

Instead of NAT traversal, most VOIP clients, including most SIP clients, can use STUN (Simple Traversal of UDP over NATs) protocol to traverse full cone, restricted cone, and port restricted cone NAT but not symmetrical NAT. In addition, some newer routers now recognize and pass SIP traffic. Furthermore, RTP Proxies, special purpose SIP line speed processors analogous to HTTP proxies commonly used in the early 1990s, enable traversal of older, SIP-unaware NAT devices. By employing such techniques, the quality of two-way voice communications over the Internet has improved to the point that several commercial offerings of VOIP telephony service, such as that offered by Vonage America Inc. of Edison N.J., are now available to the public, with many more such offerings expected in the near future.

A principal attraction of VOIP telephony is a much lower cost of communication than that for cellular or even for conventional circuit switched telephony. At the present time is it possible and even commonplace to practice some VOIP communications (e.g. between Internet connected VOIP clients when the PSTN is not used) at no increased marginal cost. However, even when engaging a paid VOIP service provider that uses the PSTN to connect a VOIP originating call to a terminating telephone number on the PSTN (or vice versa), at the present time the use of VOIP telephony is sufficiently inexpensive and its quality sufficiently acceptable as to provide a competitive alternative to traditional switched telephone service. Trends indicate that the VOIP alternative will become increasingly attractive as the technology improves and the installed base of VOIP users expands.

Wilkes et al. (U.S. Pat. No. 6,438,124) describes a standard ordinary telephone or cell phone is used to conduct voice telecommunications using VOIP technology. Significantly, though, Wilkes requires the telephone handset to connect to the PSTN in order to access the Internet to conduct VOIP telephony.

Cell phone sets that provide Internet connectivity can provide VOIP capabilities if their Internet connection has sufficient bandwidth for acceptable IP voice communications. Most cellular telephone service plans providing broadband or near-broadband Internet connectivity, however, charge a premium for online connection, and thus a user employing his/her cellular telephone service provider's Internet access for VOIP cannot realize much of the savings that is the attraction of VOIP telephony.

Another concurrent network communications development relevant to the present invention is the development and proliferation of wireless local area network (LAN) communications, in particular those enabled by the set of technologies known as IEEE 802.11 or Wi-Fi, very familiar to those in the computer networking art. Wi-Fi is a family of over-the-air modulation techniques that all employ the same underlying spread-spectrum protocol to provide reliable wireless LAN radio frequency communications. As typically employed, Wi-Fi is usually used in a point-to-multipoint configuration, wherein an access point communicates via an omni-directional antenna with one or more clients that are located in a coverage area around the access point. Current common protocols are IEEE 802.11b and 802.11g, which will often have a coverage area on the order of 100 m (328 ft.), although with high-gain external antennas the line-of-sight coverage area can be increased significantly. Using Wi-Fi enabled client hardware, a number of users may simultaneously maintain broadband connections wirelessly over the Internet via a shared wireless access point.

Wi-Fi access points are available in a large number of publicly accessible areas throughout the United States and the world, including libraries, coffee shops, hotels, airports, and, more recently, on public transportation. In major metropolitan areas worldwide, wireless broadband Internet connectivity is almost always close at hand, if not present in the user's immediate location. An emerging related standard known as WiMax promises to extend wireless coverage to about 48 km (30 mi). The WiMax technology also expands the capabilities of broadband Internet connections by enabling users to remain connected to Internet hot spots even when traveling in an automobile or train at speeds up to 250 km/h (155 mph). Because of its convenience and ease of adoption, it is generally believed that wireless connectivity will approach ubiquity in the developed world, moving outward from urban areas to provide near universal wireless broadband Internet access.

Wireless local area network communication technology has been employed to provide wireless VOIP communications in dedicated wireless VOIP handsets, such as the NetLink e340 wireless telephone manufactured by SpectraLink Corporation in Boulder, Colorado, and the Cisco Wireless IP Phone 7920 of Cisco Systems, Inc. of San Jose, Calif. In such implementations, the dedicated handset uses WiFi for transport of IP telephony communications to the LAN and to the Internet.

Multifunctional wireless communications devices, such as described by McZeal, Jr. in U.S. Pat. No. 6,763,226, employ various wireless network technologies, including cellular and VOIP to carry user calls. Such devices combine basic telephone functionality with circuitry for both cellular and VOIP communications to permit user-selectable multifunctional wireless operation.

Technology such as specified by Fors, et al. in U.S, Pat. No. 6,904,029, permits “hand-off” to a non-cellular network of calls initiated on a cellular network. Such technology, in turn, enables the functioning of hybrid telephone sets, which can provide wireless communications in which a single call is carried sequentially by cellular and VOIP technologies.

None of the foregoing technologies, however, address a need that can be readily identified: that of providing a standard cellular telephone handset with the ability directly to connect wirelessly to the Internet and conduct VOIP telephony, thereby realizing the savings in VOIP communications on an existing, inexpensive cellular telephone set.

It is desirable to enable a user of a cellular telephone handset to employ the handset to make voice telephone calls in modalities other than cellular, to take advantage of lower rates or higher service qualities offered in such modalities.

It is desirable to provide voice over IP telephony functionality for obsolete or discarded cellular telephone handsets, in order to extend the useful life of such handsets.

It is an object of the present invention to provide an apparatus which, when combined with a cellular telephone handset, allows the user to engage in non-cellular modes of voice communications, and in particular VOIP telephony communications.

It is a further object of this invention to provide non-cellular voice communications for cellular handsets wirelessly.

Other objects, advantages, features and characteristics of the present invention, as well as methods of operation and function of related elements of structure, and the combination of parts and economies of deployment, will become apparent upon consideration of the following description and claims with reference to the accompanying drawings, all of which form a part of this specification.

### BRIEF DESCRIPTION OF THE INVENTION

The present invention is an apparatus connectable to a cellular telephone handset that enables the use of the handset for telephony communications other than cellular telephone communications, in particular voice over Internet protocol communications. The apparatus comprises a connecting means, which, when connected to the cellular telephone handset, disables or bypasses cellular telephone communications by the handset and instead engages the basic telephone functionality of the handset for non-cellular telephony communications, including VOIP. Further, in preferred embodiments the apparatus is capable of providing such communications functionality wirelessly, such as via Wi-Fi. Yet further, preferred embodiments of the present invention present a small, portable form factor, allowing use of the apparatus-handset combination as portable communications device.

### BRIEF DESCRIPTION OF THE DRAWINGS

The foregoing and other aspects of the invention are further specified by the following description and by the accompanying drawings, wherein:

FIG. 1 is a block diagram depicting connection of the adapter to a cellular telephone set to provide Internet connectivity for VOIP;

FIG. 2 is a block diagram of the functionality provided by an embodiment of the adapter, including WiFi interface with VOIP capability;

FIG. 3 is a depiction of an embodiment of the present invention wherein the adapter is connected to a cellular telephone set and a separate earpiece microphone; and

FIG. 4 is a block diagram of the functionality provided in the embodiment of the invention depicted in FIG. 3.

### DETAILED DESCRIPTION OF THE PREFERRED EMBODIMENTS

The present invention is an adapter which, when connected to an ordinary cellular telephone handset, can provide other than cellular communications to the handset, in particular wireless VOIP communications.

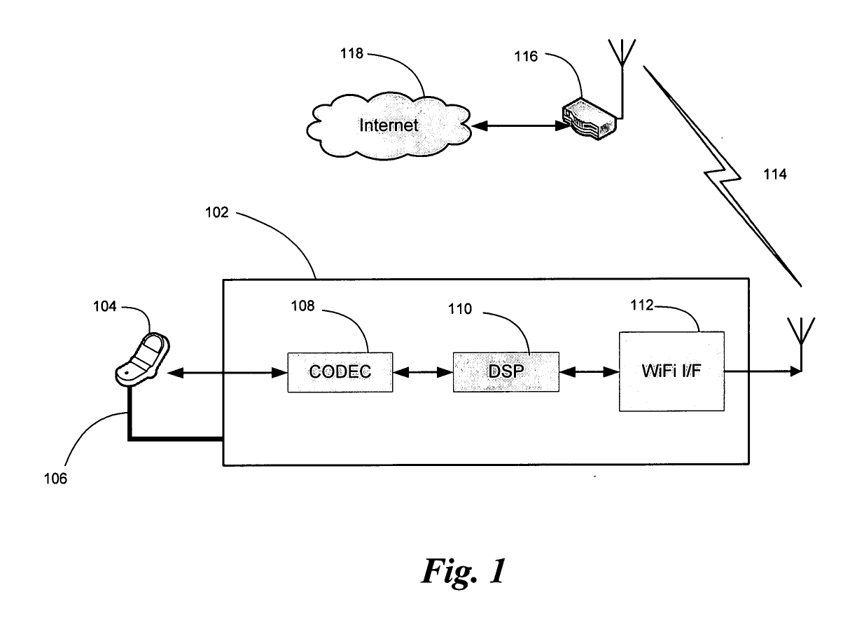

Turning to FIG. 1, depicted is a block diagram showing connection of the adapter to a cellular telephone set to provide Internet connectivity for VOIP. Cellular telephone set 104 connects to the adapter 102 via connecting means 106 which disables or bypasses cellular operation of the set and places the set in direct (possibly analog) duplex communication with adapter 102. If the cellular telephone handset is in analog communications with adapter 102, adapter 102 provides CODEC 108 which may perform analog to digital and digital to analog conversion of signals. In the alternative (not depicted), the codec for conversion of the essentially analog signaling in the basic telephone set subassembly of cellular telephone 104 into digital signals may take place internally within cellular telephone 104, in which case CODEC 108 would actually be internal to cellular telephone 104, with a digital signal is passed directly from cellular telephone 104 to adapter 102. In any case, as will be understood by those of skill in the art, digital communications passed to and from cellular telephone handset 104 further interface with digital signal processor 110, which in turn communicates with WiFi interface 112, operational to transmit packet data from DSP 110 via wireless packet communication protocol such as IEEE 802.11 b/g/a wirelessly 114 to and from wireless router 116 in communication with the Internet 118. As is well known to those in the art, with appropriate processing by DSP 110, the packetized voice data handled by wireless router 116 may comprise voice over IP protocol communications, thereby enabling cellular telephone set 104 in communication with the adapter 102 to serve as a wireless VOIP telephone handset.

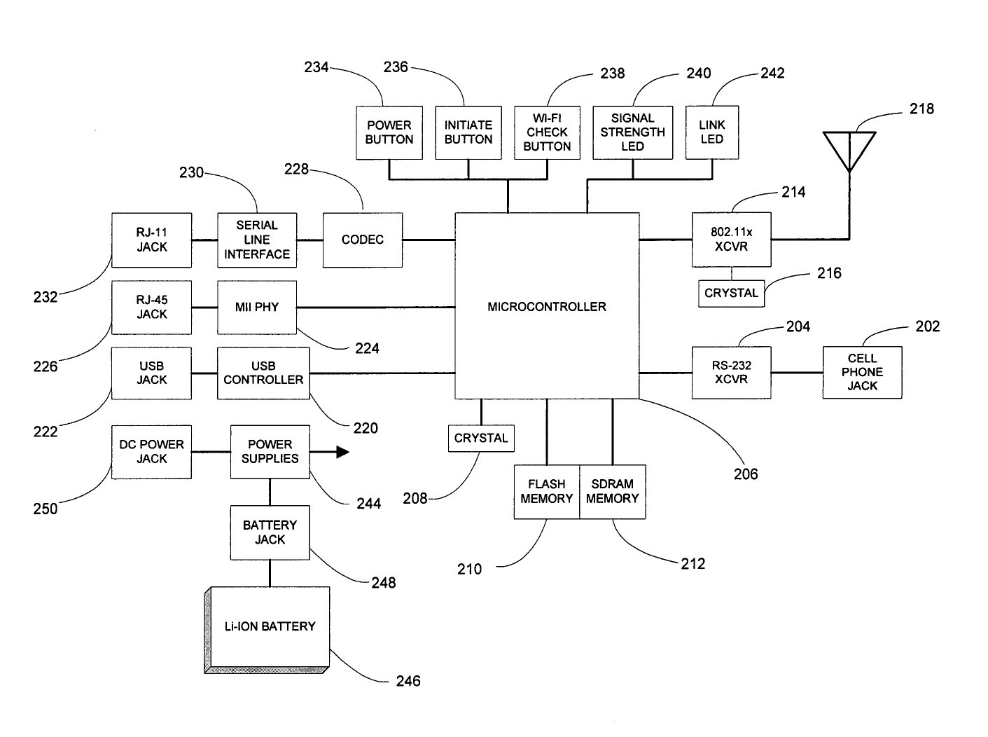

Turning now to FIG. 2, depicted is a block diagram of operational components of an embodiment of the adapter. The cellular telephone set is in communication with the adapter via cell phone jack 202. The depicted embodiment is configured to receive digital signals from the cellular telephone set, interfacing with the digital communications via transceiver 204. Transceiver 204 is selected as appropriate for the particular duplex digital communications protocol employed by the cellular telephone set. RS-232 is depicted; however, as is well known to those of skill in the art, other digital serial communications protocols, such as IEEE-48 and USB 1.X and 2.X, may be employed. Further, as will be understood by those of skill in the art, digital communications with the cellular handset may not be serial but may instead employ parallel signaling, in which case transceiver 204 will be appropriately configured for duplex parallel digital communications.

In the alternative, as discussed in reference to FIG. 1 above, communications by the adapter with the basic telephone set subassembly of the cellular telephone may be analog, in which case the functionality of receiver 204 will require employing an appropriately chosen device, such as the codec illustrated in FIG. 1, having an analog to digital converter to provide digital signals for transceiver 204 to communicate with the rest of the adapter apparatus, and a digital to analog converter to provide analog voice signals for the cellular handset, thereby permitting duplex communication between the adapter and the handset..

In any case, transceiver 204 provides duplex communication of digital voice data to microcontroller 206, which is clocked by crystal 208 and equipped with memory, shown here in the form of flash memory 210 and synchronous dynamic random access memory (SDRAM) 212. Microcontroller 206 provides digital signal processing for the digitized voice data signals passed back and forth between the adapter and the cellular telephone set via transceiver 204. In particular and advantageously, Microcontroller 206 is configured so that, in at least some modes, it processes voice data according to VOIP protocol. As will be understood by those in the art, such VOIP protocol processing functionality may be implemented in a single custom Very Large Scale Integrated Circuit (VLSI). In the alternative, such functionality may be implemented in a subassembly comprised of several discrete components, such as a microprocessor means, a memory means, and such other components necessary to provide the functionality, well known to those of skill in the art. As will be appreciated by those in the art, the present invention encompasses all means of processing duplex telephone communications according to VOIP protocol.

Microcontroller 206 further enables transmission and reception of voice data via non-cellular means, in particular via wireless network connection. As depicted, duplex wireless communications capability is provided by communication between microcontroller 206 and 802.11x transceiver 214 clocked by crystal 216, whereby packetized digital voice data is provided in the form of modulated radio signals in communication with a wireless router (as discussed in reference to FIG. 1 above) via antenna 218. As will be understood by those of skill in the art, any combination of components, either discrete or integrated, which enables processing of digitized voice data according to VOIP protocol and which further provides for duplex communication of such data via a wireless physical carrier, is within the scope of the present invention.

The depicted embodiment further enables communication of data via other means as well. Some embodiments, as depicted, permit transmission of serial digital voice data via the universal serial bus (USB) interface by duplex communications between microcontroller 206 and USB controller 220 communicating duplex data to USB jack 222, which may then connect to another USB equipped device such as a personal computer for further processing and communications. Data transmitted via such connection may either be signal data (e.g. digital voice data), or control data for configuring or controlling microcontroller 206. As will be appreciated by those of skill in the art, a configurable adapter has greater flexibility for changes in the communications environment and/or protocols.

Depicted also is an embodiment comprising a means for transmission of data via Ethernet, using media independent interface 224 to the physical layer of communications in the OSI model, in order to provide duplex communications via Ethernet protocol over RJ45 jack 226. Just as noted in the discussion above in regards to communications via the USB, such communications may comprise control or signal data. Control data may be provided by such means for the purpose of controlling or configuring microcontroller 206. In the case of voice data, it should be noted that, if microcontroller 206 provides voice data in VOIP protocol, wired connection via jack 226 to an external router connected to the Internet will permit the adapter to provide wired VOIP communication for the cellular telephone handset.

Depicted also is codec 228, which, with serial line interface 230, provides a wired connection for a standard telephone to connect to the adapter via conventional RJ11 telephone jack 232. By such means and others of equivalent functionality known to those of skill in the art, embodiments of the present invention permit a conventional telephone to be connected to the adapter, enabling the use of the conventional telephone handset to make VOIP telephone calls.

The depicted embodiment further provides a number of user controls and indicators for the adapter. The user may employ power button 234 to disable power to the adapter when it is not in use, enabling the conservation of available battery life. Initiate button 236 serves to initiate synchronization between the adapter and an available network server, while WiFi button 238 engages WiFi transceiver 214 for wireless communications. Two indicators are provided: a link LED 240, indicating when a communications link has been established, and a signal strength LED 242, providing a visual indication of the signal strength of radio signals received by antenna 218 from a remote router.

It is preferred that the adapter be embodied in a form factor consistent with portability for the cellular telephone handset. The same determinants of weight and size that are relevant to the design of cellular telephone handsets apply to the adapter, which is preferred to be sufficiently light in weight and sufficiently small in size as not unduly to reduce the utility of the cellular handset as a conveniently portable personal communications device.

Power is provided to the adapter (and perhaps to the cellular telephone set as well) via power supplies 244. Power may be received from a battery, shown here as a lithiumion battery 246 connected via battery jack 248. Power may also or alternatively be received from an external d.c. power source, such as the familiar d.c. transformer adapted to use a.c. wall current to provide d.c. power, via d.c. power jack 250. Some embodiments of the present invention replace the battery normally required for cellular telephone operation with the power supplied by the adapter. Yet further refinements of such embodiments implement the adapter in a form factor conforming to that required by the cellular telephone set for its battery, thereby enabling the adapter physically to connect to the cellular telephone set in an intuitive, user-adapted fashion.

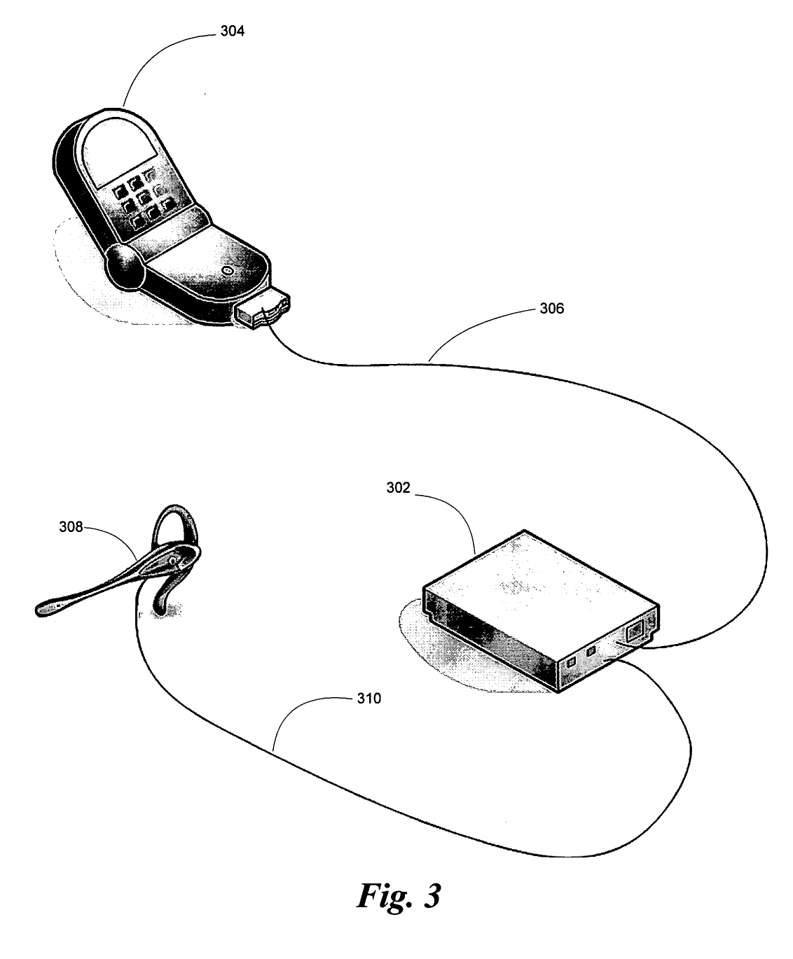

As will be clear by now to those of skill in the art, other embodiments of the present invention are possible in which fewer than all of the basic telephone functionality for voice communications is provided by the cellular telephone handset, the remaining basic telephone functionality provided instead by the adapter itself. Turning to FIG. 3, depicted is a configuration in which the adapter 302 utilizes the dialing and display capabilities of cellular telephone handset 304, to which it is connected by wired connection 306. However, the microphone and speaker functionalities of the basic telephone transceiver in handset 304 are not utilized in this embodiment, in which these functionalities are instead provided by earpiece 308, which is directly connected via wired connection 310 to device 302.

As will be clear to those in the art, a very simple embodiment of the adapter depicted in FIG. 3 may simply connect the headset connector of cellular handset 304 to adapter 302 via connection 306. The only purpose of cellular handset 304 in such embodiment is to provide a means for the user to dial digits which are then processed by adapter 302. When cellular handset 304 is powered on, the dialing of digits on the set results in their display on the display of the handset and also results in the transmission of the corresponding touch tones (dual-tone multi-frequency, or “DTMF” tones) through the headset connector. In such embodiment, adapter 302 is equipped with a DTMF decoder, enabling the adapter to determine which digits have been dialed and process them appropriately to place calls according to VOIP protocol, as described earlier. Adapter 302 is equipped with the necessary transceiver and communications converters for transmitting analog voice signals between adapter 302 and earpiece 308 for telephone communications by the user.

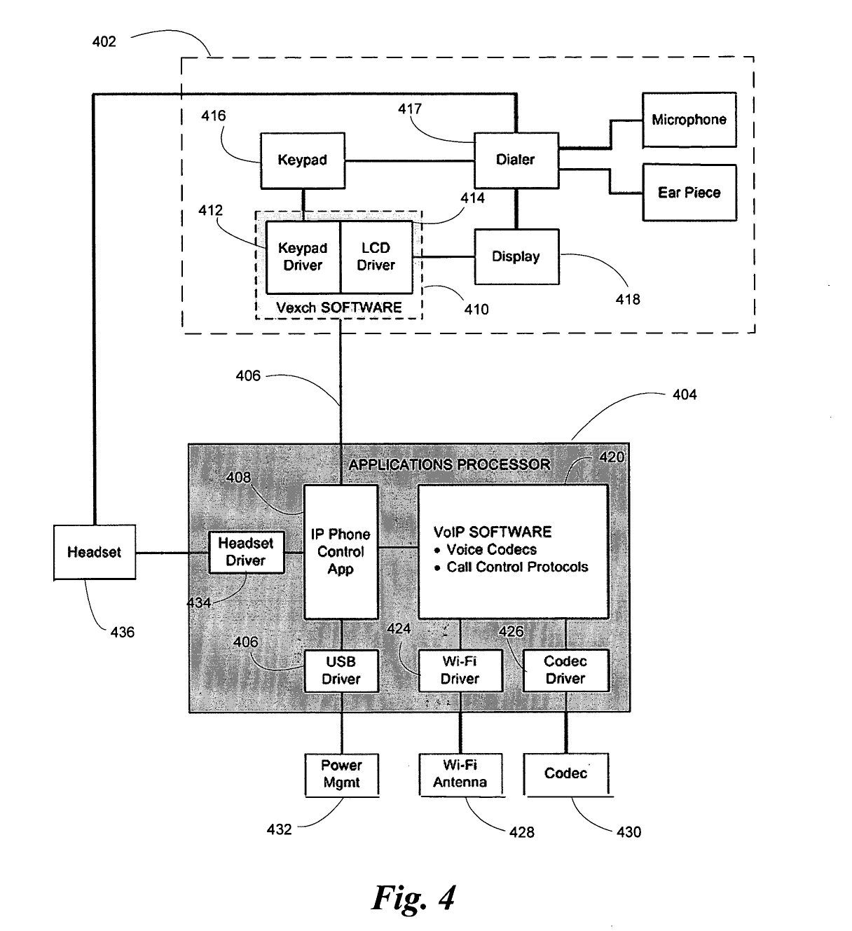

More elaborate embodiments of the adapter depicted in FIG. 3 are possible, wherein more of the intelligence of the cellular telephone handset is advantageously utilized in its combination with the adapter. Turning to FIG. 4, a block diagram is shown implementing the configuration depicted in FIG. 3. Cellular telephone handset 402 is connected to adapter 404 via USB connection 406. Adapter 404 comprises an applications processor, in which an IP phone control application 408 communicates through cellular telephone control software 410 via connection 406 with cellular handset 402. Cellular control software 410 comprises keypad driver 412, serving to transmit digits keyed by keypad 416, or digits which would otherwise be transmitted to cellular telephone dialer 417 (such as digits recalled from a telephone number directory memory resident on the cellular telephone handset), to IP phone control application 408. Cellular control software 410 further comprises LCD driver 414, serving to control cellular telephone handset display 418 to display data such as telephone numbers dialed on keypad 416 or telephone numbers recalled from a telephone number directory memory on cellular telephone handset 402. Under the control of IP phone control application 408, LCD driver 414 may further drive the display of data from adapter 404, such as VOIP call progress data, on cellular telephone display 418.

Adapter applications processor 404 further comprises VOIP software 420 in communication with IP phone control application 408. Comprised of the call control protocols and voice codecs necessary for VOIP communications that are familiar to those of skill in the art, VOIP software 420 communicates with Wi-Fi driver 424 to provide wireless network communication over Wi-Fi antenna 428. VOIP software 420 may further with codec driver 426 for communication with such external codecs (depicted herein as codec 430) as may be necessary for particular communications protocols. As depicted herein, communications for power management 432 for adapter 404 is provided through USB driver 408 in communication with IP phone control application 408.

IP phone control application 408 further comprises a headset driver, for sending and receiving analog voice data from headset 436 directly connected to adapter 404. As depicted, headset 436 further is connected to dialer 417 in cellular handset 402. (Turning momentarily to FIG. 3, it should be noted that such connection between the headset and the cellular handset need not be direct wiring between headset 308 and handset 304, but instead may be accomplished by wiring passing through adapter 302.) The connection between headset 436 and dialer 417 is so that touch-tone dialing feedback, in the form of DTMF tones are sent to the user over the earpiece of headset 436. As will be appreciated by those of skill in the art, while such embodiments are not depicted, DTMF tones indicative of dialed digits may in the alternative be generated by a DTMF generator within adapter 404 responsive to digits received by IP phone control application 408, whereby a direct connection between headset 436 and cellular telephone handset dialer 417 is not necessary. Further, while not depicted, it will be clear to those of skill in the art that the embodiments referred to in reference to FIGS. 3 and 4 may accommodate various forms of connectivity (such as USB) to other devices, in the same vein as connectivity described above in relation to embodiments referred to in reference to FIGS. 1 and 2.

Many variations of the embodiments described above are possible in keeping with the spirit of the present invention. For example, while wired connectivity between some components has been shown (such as depicted by wired connections 306 and 310 in FIG. 3), as is well known to those of skill in the art, signaling connectivity may in the alternative be provided wirelessly and, provided electrical power is otherwise supplied, wired connections may be dispensed with. So, for example, if self-powered, headset 308 may connect wirelessly to adapter 302 via a wireless protocol, such as IEEE 802.15.1 (known as Bluetooth®).

Yet further, a wide variety of embodiments of the present invention are possible beyond the embodiments described above in detail. For example, while the detailed descriptions have focused on relatively short-range wireless communications under WiFi, such as those commonly provided under IEEE 802.11a/b/g protocols at the time of filing, the present invention is equally suited to wireless networked communications under WiMax protocols such as discussed earlier, permitting communication by an adapter-equipped cellular telephone handset at significant distance from a corresponding wireless router. The present invention may be embodied to practice any form of wireless network communications protocol, so long as bandwidth sufficient for VOIP communications is provided.

Further still, at least a portion of the software employed by the present invention may be specified via a removable memory module, such as flash memory, permitting personalized operation of the adapter (for example, removably storing the originating telephone number for VOIP service). Yet further, such a removable memory module may facilitate business models built around the provision of VOIP service, in manner analogous to that whereby the cellular telephone Subscriber Identity Module (SIM card) facilitates certain cellular telephone service business models, including, in particular, the highly successful model of prepaid telephone service.

In addition, while the present discussion has focused on utilizing the network connectivity of the adapter to provide VOIP communications via the cellular telephone handset, such network connectivity in conjunction with the cellular handset may also be used advantageously for other purposes. As stated earlier, many modern cellular handsets are equipped with color graphic displays and Internet browser software. The Internet connectivity provided by the adapter over a wireless IP connection is a considerably lower cost alternative than Internet connectivity over a cellular telephone connection. For browser equipped handset users, therefore, a properly equipped adapter providing hypertext markup language (HTML) to the cellular handset's browser can enable a user to browse the Internet on the cell phone at considerable savings.

CONCLUSIONS, RAMIFICATIONS, AND SCOPE

Accordingly, it can be seen that the invention described herein provides an adapter for a cellular telephone set that enables the use of the handset for wireless voice over Internet protocol communications. Some embodiments further provide for signaling and/or control communications over a serial interface such as the Universal Serial Bus. Some embodiments of the present invention further enable communication over wired connection, such as Ethernet. Some embodiments further provide a means for using the adapter to provide VOIP capabilities for wired standard telephone sets. Some embodiments further provide power to the cellular telephone set. It is preferred that the adapter be embodied in a form factor appropriate for portability, with some embodiments implemented in a form factor conforming to that of the cellular handset battery, further enhancing portability and utility.

Although the detailed descriptions above contain many specifics, these should not be construed as limiting the scope of the invention but as merely providing illustrations of some of the presently preferred embodiments of this invention. Various other embodiments and ramifications are possible within its scope, a number of which are discussed in general terms above.

While the invention has been described with a certain degree of particularity, it should be recognized that elements thereof may be altered by persons skilled in the art without departing from the spirit and scope of the invention. Accordingly, the present invention is not intended to be limited to the specific forms set forth herein, but on the contrary, it is intended to cover such alternatives, modifications and equivalents as can be reasonably included within the scope of the invention. The invention is limited only by the following claims and their equivalents.

I claim:

1. An apparatus for wireless voice over internet protocol communications, comprising a cellular telephone handset; and
an adapter in communication with the handset, the adapter further comprising
a means for controlling the basic telephone functionality of the cellular telephone handset;
a means for transmitting and receiving voice signal data with the cellular telephone handset;
a means for packetizing voice signal data communicated with the cellular telephone handset along with control data according to voice over internet protocol; and
a means for wirelessly communicating packetized data with a wireless network router.

2. An adapter enabling a cellular telephone handset to be used for wireless voice over internet protocol communications, the adapter comprising
a means for controlling the basic telephone functionality of a cellular telephone handset;
a means for transmitting and receiving voice signal data with the cellular telephone handset;
a means for packetizing voice signal data communicated with the cellular telephone handset along with control data according to voice over internet protocol; and
a means for wirelessly communicating packetized data with a wireless network router.

3. A method of using a cellular telephone handset for wireless voice over internet protocol communications, comprising
controlling the basic telephone functionality of the handset;
communicating voice signal data with the handset;
packetizing voice signal data communicated with the handset along with control data according to voice over internet protocol; and
communicating packetized data wirelessly with a network router.

4. An apparatus for wireless voice over internet protocol communications, comprising a cellular telephone handset; and
an adapter in communication with the handset, the adapter further comprising
a means for receiving dialed digits information from the handset;
an input transducer means for transforming sounds to voice signal data;
an output transducer means for transforming voice signal data to sound;
codecs for processing voice signal data;
a means for packetizing processed voice signal data along with control data according to voice over internet protocol; and
a means for wirelessly communicating packetized data with a wireless network router.

5. An apparatus for wireless voice over internet protocol communications according to claim 4, wherein the handset further comprises a display, the apparatus further comprising a means for transmitting call information from the adapter to the handset.

6. An apparatus for wireless voice over internet protocol communications according to claim 4, wherein the cellular telephone handset further comprises a dialing keypad and a memory containing retrievable digits, and the dialed digits information further comprises at least one of digits dialed by a user and digits retrieved from the memory.

7. An adapter enabling a cellular telephone handset to be used for wireless voice over internet protocol communications, the adapter comprising
a means for receiving dialed digits information from the handset;
an input transducer means for transforming sounds to voice signal data;
an output transducer means for transforming voice signal data to sound;
codecs for processing voice signal data;
a means for packetizing processed voice signal data along with control data according to voice over internet protocol; and
a means for wirelessly communicating packetized data with a wireless network router.

8. Employing a cellular telephone handset having a keypad, the handset in communication with a wireless apparatus, the wireless apparatus adapted for voice over internet protocol communication and wirelessly connected to the internet, a method of using the cellular telephone handset to place a wireless voice over internet protocol call, comprising
dialing the digits of a desired telephone number on the cellular telephone handset keypad;
communicating the dialed digits from the cellular telephone handset to the wireless apparatus; and
placing the call with the wireless apparatus to the desired number on voice over internet protocol.

9. A method of using the cellular telephone handset to place a wireless voice over internet protocol call according to claim 8 wherein the cellular telephone handset has a display, further comprising
communicating outgoing call progress information from the wireless apparatus to the cellular telephone handset; and
displaying the call progress information on the cellular telephone handset display.

10. Employing a cellular telephone handset comprising basic telephone functionality, the handset in communication with a wireless apparatus, the wireless apparatus adapted for voice over internet protocol communication and wirelessly connected to the internet, a method of using the cellular telephone handset to receive a wireless voice over internet protocol telephone call, comprising
receiving an incoming voice over internet protocol telephone call on the wireless apparatus, and
cutting the call through to the basic telephone functionality of the cellular telephone handset.

11. A method of using the cellular telephone handset to receive a wireless voice over internet protocol telephone call according to claim 10, wherein the cellular telephone handset has a display, further comprising
communicating incoming call progress information from the wireless apparatus to the cellular telephone handset; and
displaying the call progress information on the cellular telephone handset display.

12. Employing a cellular telephone handset having a display, the handset in communication with a wireless apparatus, the wireless apparatus adapted for voice over internet protocol communication and wirelessly connected to the internet, a method of
receiving a wireless voice over internet protocol telephone call, comprising receiving an incoming voice over internet protocol telephone call on the wireless apparatus;
communicating incoming call progress information from the wireless apparatus to the cellular telephone handset; and
displaying the call progress information on the cellular telephone handset display.
